(19) United States
(12) Patent Application Publication
(10) Pub. No.: US 2018/0134100 A1
(43) Pub. Date: May 17, 2018

(54) PNEUMATIC TIRE

(71) Applicant: Toyo Tire & Rubber Co., Ltd., Itami-shi (JP)

(72) Inventor: Yuya Kawaguchi, Itami-shi (JP)

(73) Assignee: Toyo Tire & Rubber Co., Ltd., Itami-shi (JP)

(21) Appl. No.: 15/810,501

(22) Filed: Nov. 13, 2017

(30) Foreign Application Priority Data
Nov. 14, 2016 (JP) 2016-221734

(51) Int. Cl. B60C 15/06; B60C 9/11; B60C 9/08; B60C 15/00

(52) U.S. Cl. CPC B60C 15/0635; B60C 9/11; B60C 2009/0276; B60C 15/0036; B60C 15/0653; B60C 9/08

(57) ABSTRACT

A pneumatic tire includes an up ply, a down ply, and a cord reinforcing layer. The up ply has: a main body section and a wound section. The down ply is provided on a tire outer surface side of the up ply. The cord reinforcing layer is provided from the inner side to the outer side in the tire axial direction of the bead core to cover the up ply, and has reinforcing cords. A tip of the wound section is located outward in a tire radial direction from a rim flange. An outer end in the tire axial direction of the cord reinforcing layer is located outward in the tire radial direction from a bead upper line and inward in the tire radial direction from the rim flange. The bead upper line extends from an outer surface in the tire radial direction of the bead core.

### BACKGROUND OF THE INVENTION

### 1. Field of the Invention

The invention relates to a pneumatic tire.

### 2. Description of the Related Art

An example of a pneumatic tire is disclosed in JP-A-55-29608. The example of the pneumatic tire includes: an up ply (also referred to as an inner carcass ply or the like) that is folded around a bead core from an inner side to an outer side in a tire axial direction and is wound up; and a down ply (also referred to as an outer carcass ply or the like) that is provided on the outer side in the tire axial direction of the upper ply.

Durability of such a pneumatic tire can be secured while an increase in tire mass is suppressed by reducing volumes of metal cords and organic fiber cords used for the tire. Meanwhile, when the tire is attached to a rim or detached from the rim, the tire possibly rubs against a rim flange, which damages a portion of the up ply provided in a bead section. Because the up ply functions as a framework that supports the tire between a pair of the bead sections, the damage of the up ply significantly degrades the durability of the tire.

### SUMMARY OF THE INVENTION

In view of the above point, the invention has a purpose of providing a pneumatic tire in which a portion of an up ply provided in a bead section is unlikely to be damaged during attachment and detachment of the up ply to/from a rim while an increase in tire mass and degradation of durability of the tire are suppressed.

A pneumatic tire according to an embodiment includes: a pair of bead sections, each of which has a bead core and a bead filler that is disposed on an outer side in a tire radial direction of the bead core; an up ply having: a main body section that is provided between the pair of bead sections; and wound sections, each of which extends from the main body section, is folded around the bead core from an inner side to an outer side in a tire axial direction, and is wound up to the outer side in the tire radial direction; a down ply that is provided on a tire outer surface side of the up ply and has portions, each of which overlaps the wound section in the tire axial direction; and cord reinforcing layers, each of which is provided from the inner side to the outer side in the tire axial direction of the bead core to cover the up ply around the bead core and has reinforcing cords. In the pneumatic tire, a tip of each of the wound sections is located outward in the tire radial direction from a rim flange. An outer end in the tire axial direction of each of the cord reinforcing layers is located outward in the tire radial direction from a bead upper line and is located inward in the tire radial direction from the rim flange, and the bead upper line extends from an outer surface in the tire radial direction of the bead core. An inner end in the tire axial direction of each of the cord reinforcing layers is located outward in the tire radial direction from the rim flange.

### BRIEF DESCRIPTION OF THE DRAWINGS

FIG. 1 is a meridian cross-sectional view of a half portion of a pneumatic tire according to one embodiment.

FIG. 2 is an enlarged view of a bead section in FIG. 1.

FIG. 3 is a view of a wound section of an up ply and a cord reinforcing layer in FIG. 1 that are seen from an outer side in a tire axial direction, and depicts inclination angles and inclination directions of first reinforcing cords and second reinforcing cords with respect to ply cords provided in the wound section, the first reinforcing cords and the second reinforcing cords being provided in the cord reinforcing layer.

FIG. 4 is an enlarged meridian cross-sectional view of a bead section of a pneumatic tire according to Comparative Example 1.

FIG. 5 is an enlarged meridian cross-sectional view of a bead section of a pneumatic tire according to Comparative Example 2.

FIG. 6 is an enlarged meridian cross-sectional view of a bead section of a pneumatic tire according to Comparative Example 3.

### DESCRIPTION OF THE PREFERRED EMBODIMENTS

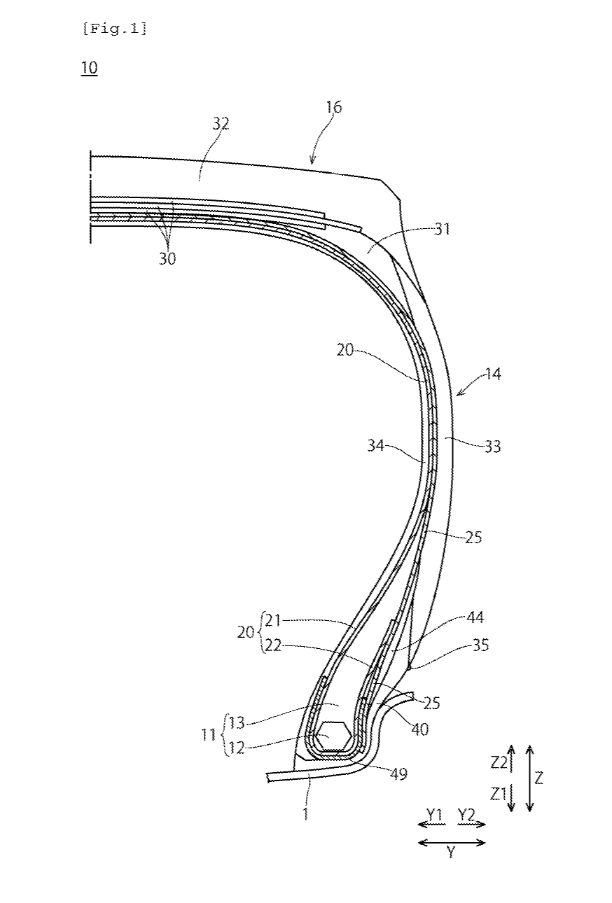

A description will hereinafter be made on an embodiment of the invention with reference to the drawings. FIG. 1 is a meridian cross-sectional view of one example of a pneumatic tire (hereinafter referred to as a “tire”) 10 according to a first embodiment, and depicts a half portion of a cross section of the tire 10 that is attached to a rim flange 1 of a prescribed rim.

In this specification, a tire axial direction is a direction parallel to a tire rotation axis, has the same definition as a tire width direction, and is denoted by a reference sign Y in the drawings. An inner side and an outer side in the tire axial direction are denoted by reference signs Y1, Y2, respectively. A tire radial direction (a radial direction) is a direction perpendicular to the tire rotation axis and is denoted by a reference sign Z in the drawings. An inner side and an outer side in the tire radial direction are denoted by reference signs Z1, Z2, respectively.

The tire 10 of this embodiment includes: a right and left pair of bead sections 11 provided on both sides in the tire axial direction Y; a pair of sidewall sections 14 extending from the bead section 11 to the outer side in the tire radial direction; and a tread section 16 provided between both of the sidewall sections 14 to couple outer ends in the tire radial direction of the right and left sidewall sections 14.

Each of the bead sections 11 has: an annular bead core 12 formed as a bundle of bead wires that are coated with rubber and wound around for lamination; and a bead filler 13 that is made of rubber and disposed on the outer side Z2 in the tire radial direction of this bead core 12.

Two sheets of carcass plies are provided in the tire 10, and the carcass plies include an up ply 20 and a down ply 25. The up ply 20 and the down ply 25 are each provided from the tread section 16 to the bead sections 11 through the sidewall sections 14. Both ends of each of the up ply 20 and the down ply 25 are locked in the bead sections 11. The up ply 20 and the down ply 25 are each formed by arranging plural ply cords 17 along a direction that is substantially orthogonal to a tire circumferential direction (that is, along the tire axial direction Y) with the plural ply cords 17 coated with rubber. As the ply cords 17, metal cords, organic fiber cords, or the like are used. An example of the metal cord is a steel cord, and the organic fiber cord is made of polyester, nylon, or the like.

In the tread section 16, belts 30 are provided on a tire outer surface side of the down ply 25. Each of the belts 30 is formed of plural cords (for example, the plural steel cords) that are coated with rubber, and reinforces the tread section 16 on outer circumferences of the two carcass plies 20, 25. An under-belt pad 31 is provided between the down ply 25 and each end in the tire width direction of the belt 30. Tread rubber 32 is provided on the outer side in the tire radial direction of the belts 30, and an outer surface of the treat rubber 32 functions as a ground contact surface.

On a tire inner surface side of the up ply 20, an inner liner 34 is provided as an air-impermeable rubber layer and constitutes an inner circumferential surface of the tire 10. In each of the sidewall sections 14, sidewall rubber 33 is provided on the outer side in the tire axial direction Y of the down ply 25, and constitutes an outer wall surface of the tire 10.

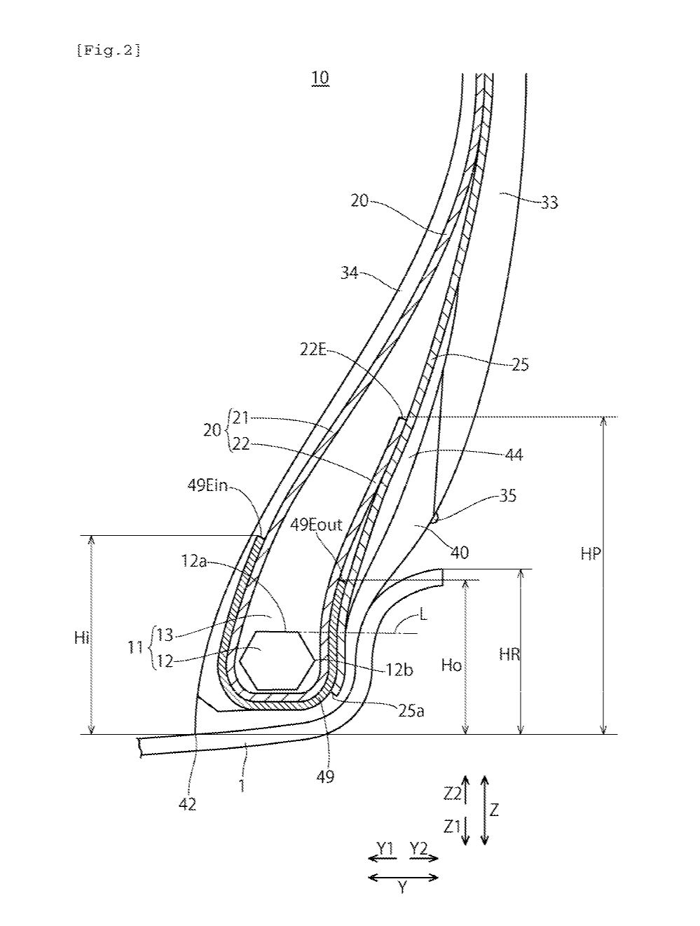

FIG. 2 illustrates a structure of the bead section 11 and components therearound. A reinforcing rubber layer 40, which is referred to as a rubber chafer, is provided on the tire outer surface side of a cord reinforcing layer 49, which is provided in the bead section 11, and the down ply 25. An upper portion of the reinforcing rubber layer 40 is in contact with a lower portion of the sidewall rubber 33. A lower portion of the reinforcing rubber layer 40 is located on the inner side Z1 in the tire radial direction from the bead core 12. The reinforcing rubber layer 40 comes in contact with the rim flange 1 on the outer side Y2 in the tire axial direction and on the inner side Z1 in the tire radial direction of the bead core 12.

Rubber that constitutes this reinforcing rubber layer 40 has a higher modulus in 100% elongation than rubber that constitutes the sidewall rubber 33 provided in the sidewall section 14, and preferably has the modulus in 100% elongation that is twice or three times as high as that of the rubber constituting the sidewall rubber 33. For example, in the case where the sidewall rubber 33 has the modulus of 1.2 to 2.2 MPa in 100% elongation, the reinforcing rubber layer 40 can have the modulus of 3.5 to 4.5 MPa in 100% elongation. Here, the modulus in 100% elongation refers to a modulus value measured in a tensile test that conforms to JIS K6251.

A rim line 35 is provided as a small projection at a specified position on a front tire surface. The rim line 35 is a line used to confirm that the tire 10 and a legitimate rim are coaxial when the tire 10 is attached to the legitimate rim. For this purpose, the rim line 35 is provided for a whole circumference in the tire circumferential direction, and defines a circle that is centered on the rotation axis of the tire 10. The specified position at which the rim line 35 is provided is a position at which the rim line 35 is located on the outer side in the tire radial direction of an outer circumference of a flange in the legitimate rim by a specified distance. As depicted in FIG. 2, the rim line 35 is usually provided in a boundary portion between the reinforcing rubber layer 40 and the sidewall rubber 33 on the front tire surface.

The up ply 20 has: a main body section 21 that is provided between the pair of the bead sections 11 and forms a framework of the tire; and wound sections 22, each of which extends from the main body section 21, is folded around the bead section 11 from the inner side to the outer side in the tire axial direction, and is wound up to the outer side Z2 in the tire radial direction.

The wound section 22 of the up ply 20 is disposed along outer surfaces in the tire axial direction of the bead core 12 and the bead filler 13. A tip of this wound section 22 (that is, an outer end in the tire radial direction of the wound section 22) is a wound end 22E, and is located outward in the tire radial direction from the rim flange 1.

Around the bead core 12, which is provided in the bead section 11, the cord reinforcing layer 49 is formed by coating plural reinforcing cords 50 with rubber, and is provided from the inner side Y1 to the outer side Y2 in the tire axial direction of the bead core 12 to overlap and cover the up ply 20.

A tip (also referred to as an outer end in the tire axial direction) 49Eout of the cord reinforcing layer 49 that is located on the outer side Y2 in the tire axial direction of the bead core 12 (or the bead filler 13) is located outward Z2 in the tire radial direction from a bead upper line L, and is located inward Z1 in the tire radial direction from the rim flange 1. The bead upper line L extends from an outer surface 12a in the tire radial direction of the bead core 12.

A tip (also referred to as an inner end in the tire axial direction) 49Ein of the cord reinforcing layer 49 that is located on the inner side Y1 in the tire axial direction of the bead core 12 (or the bead filler 13) is located outward Z2 in the tire radial direction from the rim flange 1.

At a position between the pair of the bead sections 11, the down ply 25 is provided on the tire outer surface side of the up ply 20. The down ply 25 overlaps the main body section 21 of the up ply 20 in the sidewall section 14 and the tread section 16, and overlaps the wound section 22 of the up ply 20 and the cord reinforcing layer 49 in the bead section 11.

A tip 25a on the inner side in the tire radial direction of the down ply 25 is located on the inner side in the tire radial direction of a center of the bead core 12, and is located on the outer side in the tire width direction of an outer end 12b in the tire width direction of the bead core 12. Here, the center of the bead core 12 is the center of the bead core 12 in the tire width direction at a position where the bead core 12 is the longest in the tire width direction.

Positions of the ends of the up ply 20 and the cord reinforcing layer 49 will be exemplified herein with reference to FIG. 2. In the case where length HR in the tire radial direction Z from a bead toe 42 to an outer end in the tire radial direction of the rim flange 1 is 17.5 mm, length HP in the tire radial direction Z from the bead toe 42 to a tip 22E of the wound section 22 in the up ply 20 can be set to 30 to 40 mm, length Ho in the tire radial direction Z from the bead toe 42 to the outer end 49Eout in the tire axial direction of the cord reinforcing layer 49 can be set to 10 to 17 mm, and length Hi in the tire radial direction Z from the bead toe 42 to the inner end 49Ein in the tire axial direction of the cord reinforcing layer 49 can be set to 17 to 28 mm.

Note that preferred dimension values of the up ply 20, the cord reinforcing layer 49, and the bead upper line L as well as the above-described preferred dimensional values in this specification are acquired in an unloaded legitimate state where the tire is attached to the legitimate rim and filled with legitimate inner pressure. In a system of standards that include standards with which the tire complies, the legitimate rim means a rim that is defined by the standard set per tire, and is specified as the “standard rim” in JATMA standards, the “Design Rim” in TRA standards, and the “Measuring Rim” in ETRTO standards. In addition, in the system of the standards that includes the standards with which the tire complies, the legitimate inner pressure means inflation pressure that is defined by each of the standards set per tire, and is specified as the “maximum inflation pressure” in the JATMA standards, a maximum value set in the “TIRE LOAD LIMITS AT VARIOUS COLD INFLATION PRESSURES” in the TRA standards, and the “INFLATION PRESSURE” in the ETRTO standards.

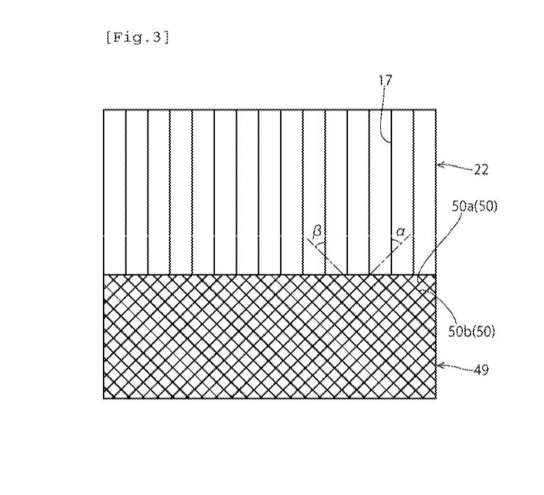

In this embodiment, as a preferred mode, as depicted in FIG. 3, the reinforcing cords 50 that constitute the cord reinforcing layer 49 include: plural first reinforcing cords 50a that are arranged in parallel; and plural second reinforcing cords 50b that are arranged in parallel at a different angle from the first reinforcing cords 50a. The first reinforcing cords 50a and the second reinforcing cords 50b constitute a plain-woven structure in which the first reinforcing cords 50a and the second reinforcing cords 50b are inclined in reverse directions from each other and cross each other with respect to the ply cords 17 of the up ply 20 and the down ply 25 and are arranged to define a mesh pattern.

Angles of the first reinforcing cords 50a and the second reinforcing cords 50b with respect to the ply cords 17 are not limited. However, the first reinforcing cords 50a and the second reinforcing cords 50b preferably have a large crossing angle, and the large angles are preferably set for the first reinforcing cords 50a and the second reinforcing cords 50b with respect to the ply cords 17. Each of the first reinforcing cords 50a can define an angle α of +35° to +55° with respect to the ply cords 17. Each of the second reinforcing cords 50b can define an angle β of −35° to −55° with respect to the ply cords 17.

The first reinforcing cords 50a and the second reinforcing cords 50b are each formed of organic fiber such as an aliphatic polyamide resin (a nylon resin) or a polyester resin. Examples of the aliphatic polyamide resin (the nylon resin) are nylon 6 and nylon 66. An example of the polyester resin is polyethylene terephthalate (PET). A diameter of each of the first reinforcing cord 50a and the second reinforcing cord 50b is approximately 0.1 to 0.5 am, for example. These cords are arranged at equally-spaced intervals of approximately 10 to 15 mm, for example.

In addition, in this embodiment, as a preferred mode, the inner end 49Ein in the tire axial direction of the cord reinforcing layer 49 is located inward Z1 in the tire radial direction from the wound end 22E of the up ply 20.

Furthermore, in this embodiment, as a preferred mode, a cushion rubber layer 44 is provided between the down ply 25 and the reinforcing rubber layer 40. Since the reinforcing rubber layer 40 is located on the outer side Y2 in the tire axial direction of the cushion rubber layer 44, the cushion rubber layer 44 is not exposed to the tire outer surface and thus does not contact the rim flange 1.

Moreover, as a preferred mode, the cushion rubber layer 44 and the like have the following moduli. The modulus of the cushion rubber layer 44 is equal to or lower than the modulus of the bead filler 13, and is desirably equal to or higher than 85% and equal to or lower than 90% of the modulus of the bead filler 13. Each of the moduli herein corresponds to the modulus in 100% elongation, and the modulus in 100% elongation is measured in the tensile test that conforms to JIS K6251.

In the pneumatic tire 10 of this embodiment, the outer end 49Eout in the tire axial direction of the cord reinforcing layer 49 is located outward Z2 in the tire radial direction from the bead upper line L, which extends from the outer surface 12a in the tire radial direction of the bead core 12. The inner end 49Ein in the tire axial direction of the cord reinforcing layer 49 is located outward Z2 in the tire radial direction from the bead upper line L and the outer end in the tire radial direction of the rim flange 1. In this way, the cord reinforcing layer 49 is disposed to cover the entire bead core 12 from the outer side of the up ply 20 to the inner side of the bead core 12 in the tire radial direction, and thus a reinforcing effect around the bead core 12 by the cord reinforcing layer 49 can be enhanced.

In this embodiment, the outer end 49Eout in the tire axial direction of the cord reinforcing layer 49 is located inward Z1 in the tire radial direction from the outer end in the tire radial direction of the rim flange 1, and opposes the rim flange 1 in the tire axial direction Y in a state where the tire 10 is attached to the rim flange 1. In this way, the outer end 49Eout in the tire axial direction of the cord reinforcing layer 49 is held between either one of the bead core 12 and the bead filler 13 and the rim flange 1, and movement of the outer end 49Eout in the tire axial direction of the cord reinforcing layer 49, which is generated when the tire is deformed, is suppressed by the rim flange 1. Thus, it is possible to suppress generation of shear strain between the cord reinforcing layer 49 and each one of the up ply 20 and the down ply 25, which are superimposed on the cord reinforcing layer 49. Therefore, durability of the tire 10 can be improved.

In this embodiment, the inner end 49Ein in the tire axial direction of the cord reinforcing layer 49 is located outward Z2 in the tire radial direction from the outer end in the tire radial direction of the rim flange 1. In this way, an entire portion of the up ply 20 that is likely to rub against the rim flange 1 at a time when the tire 10 is attached to the rim or is detached from the rim can be covered with and protected by the cord reinforcing layer 49. Thus, damage to the up ply 20 can be suppressed during the attachment of the tire 10 to the rim and during the detachment of the tire 10 from the rim.

In this embodiment, since the wound end 22E of the up ply 20 is located outward Z2 in the tire radial direction from the rim flange 1, the bead filler 13 can be prevented from being collapsed in the tire axial direction Y. Therefore, the durability of the tire 10 can be improved.

In this embodiment, since the first reinforcing cords 50a and the second reinforcing cords 50b, which are provided in the cord reinforcing layer 49, constitute the plain-woven structure in which the first reinforcing cords 50a and the second reinforcing cords 50b are arranged in the mesh pattern, the reinforcing effect by the cord reinforcing layer 49 can be enhanced. In particular, in this embodiment, the first reinforcing cords 50a and the second reinforcing cords 50b are inclined in the reverse directions from each other and cross each other with respect to the ply cords 17 of the up ply 20 and the down ply 25. In this way, tensile forces generated in the first reinforcing cords 50a and the second reinforcing cords 50b act on the up ply 20 and the down ply 25 in two directions and cancel each other. Thus, a phenomenon called ply cord wave in which the ply cords 17 provided along the tire axial direction Y are curved in the tire circumferential direction is less likely to occur, and durability of the bead section 11 can be improved.

The embodiment of the invention has been described so far. This embodiment is merely provided as an example and thus has no intention of limiting the scope of the invention. This novel embodiment can be implemented in any of various other modes, and various types of elimination, replacement, and changes can be made thereto within the scope that does not depart from the gist of the invention.

### EXAMPLES

In order to specifically indicate the configuration and the effects of the above embodiment, prototypes of a pneumatic tire in size of 205/85R16 were produced to evaluate performance thereof. An evaluation method is as follows.

(1) External Damage Resistance of a Rim Contact Portion

Each of the prototype tires was mounted on the standard rim of the JATMA standards, and was then detached from the standard rim. Thereafter, each of the prototype tires was observed to check presence or absence of damage on contact portions of the up ply and the down ply with the rim flange. The prototype tire with no damage on the up ply and the down ply was evaluated with “∘”. The prototype tire with the damage on either one or both of the up ply and the down ply was evaluated with “x”.

(2) Tire Durability

Each of the prototype tires was mounted on the standard rim of the JATMA standards, was brought into contact with a test drum, and started running. A running speed of each of the prototype tires was 55% of a permissible speed that is specified by a speed rating of the tire. An initial applied load was 70% of the maximum applied load that was specified by a load index. Thereafter, steps were sequentially shifted. In step 1 to step 3, the applied load was increased by 18% (18% of the applied load in the previous step) per step. The applied load was increased by 9% from step 3 to step 4, 15% from step 4 to step 5, and 30% from step 5 to step 6. In step 7 onward, the tire run with the final applied load. After 7 hours elapsed in step 1, the step was shifted to step 2. Then, after 16 hours elapsed in step 2, the step was shifted to step 3. Thereafter, the step was shifted every 24 hours. The prototype tire stopped running when the prototype tire malfunctioned. In this way, a running duration until occurrence of the malfunction was checked for each of the prototype tires. Then, the running duration of each of the prototype tires was converted to a relative index with the running duration in Comparative Example 1 being 100. It is indicated that, as the index is increased, the running duration until the occurrence of the malfunction extends, and thus the durability is superior.

(2) Tire Mass

Mass of each of the prototype tires was measured and recorded as an index with the mass in Comparative Example 1 being 100. It is indicated that, as the index becomes smaller, the mass is reduced.

The prototype tires, the performance of each of which was evaluated, were as follows. Note that, in each of the prototype tires, the length HR in the tire radial direction Z from the bead toe 42 to the outer end in the tire radial direction of the rim flange 1, the length HP in the tire radial direction Z from the bead toe 42 to the tip 22E of the wound section 22 in the up ply 20, the length Ho in the tire radial direction Z from the bead toe 42 to the outer end 49Eout in the tire axial direction of the cord reinforcing layer 49, and the length Hi in the tire radial direction Z from the bead toe 42 to the inner end 49Ein in the tire axial direction of the cord reinforcing layer 49 were as indicated in Table 1.

### Example 1

Example 1 relates to the tire in which the bead section is configured as depicted in FIG. 1 and FIG. 2 according to the embodiment.

### Comparative Example 1

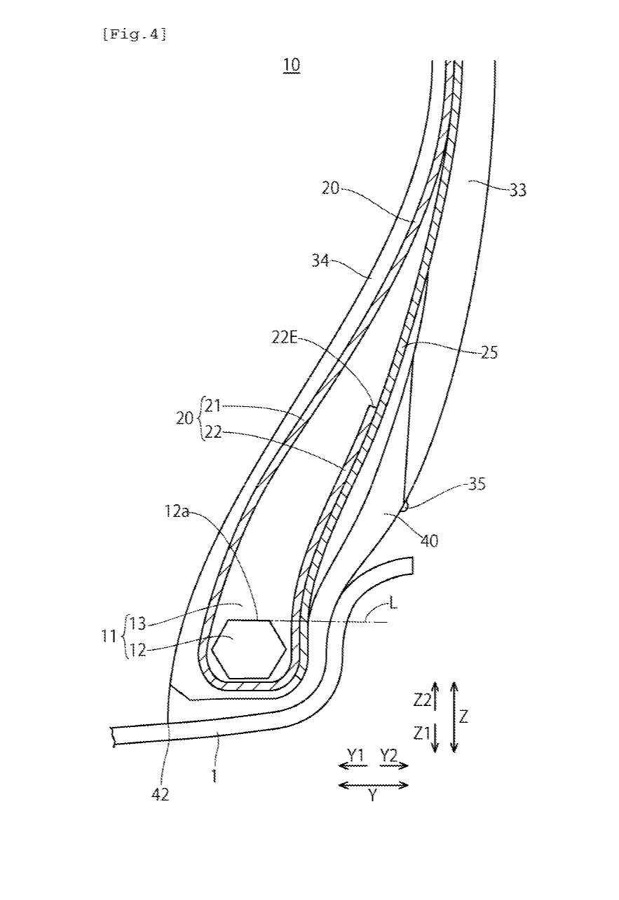

Comparative Example 1 relates to a tire as depicted in FIG. 4, and the tire is not provided with the cord reinforcing layer 49. The rest of the configuration of the tire is the same as that in Example 1.

### Comparative Example 2

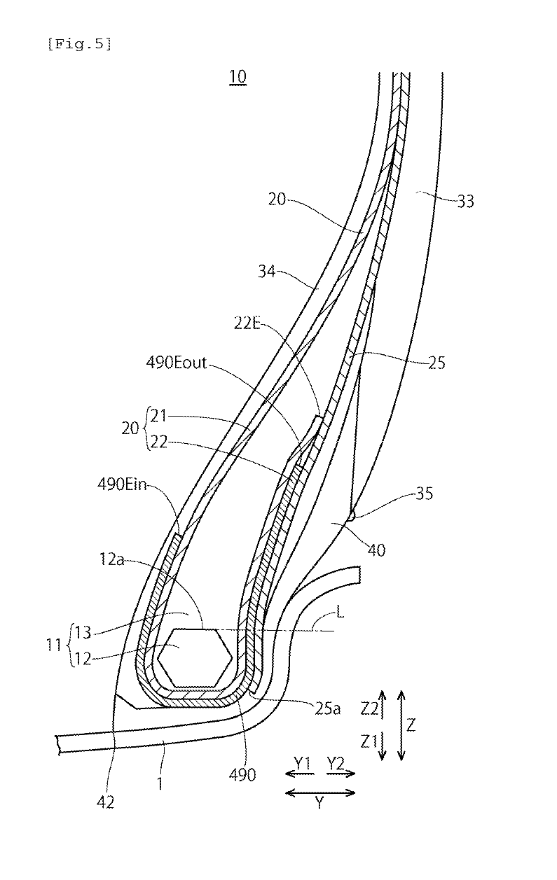

Comparative Example 2 relates to a tire as depicted in FIG. 5. A cord reinforcing layer 490 is provided from the inner side to the outer side in the tire axial direction of the bead core 12 to cover the up ply 20 around the bead core 12. An outer end 490Eout in the tire axial direction of the cord reinforcing layer 490 is located outward Z2 in the tire radial direction from the rim flange 1. The rest of the configuration of the tire is the same as that in Example 1.

### Comparative Example 3

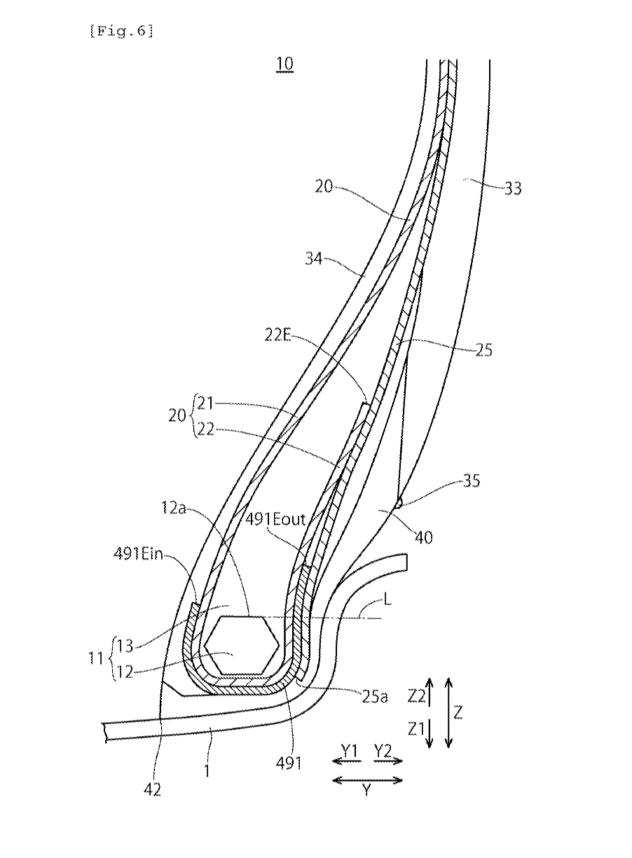

Comparative Example 3 relates to a tire as depicted in FIG. 6. A cord reinforcing layer 491 is provided from the inner side to the outer side in the tire axial direction of the bead core 12 to cover the up ply 20 around the bead core 12. An inner end 491Ein in the tire axial direction of the cord reinforcing layer 491 is located inward Z1 in the tire radial direction from the rim flange 1. The rest of the configuration of the tire is the same as that in Example 1.

TABLE 1

| | Comparative | Comparative | Comparative | |
|---|---|---|---|---|
| | Example 1 | Example 2 | Example 3 | Example 1 |
| Presence/absence | Absent | Present | Present | Present |
| of cord | | | | |
| reinforcing | | | | |
| layer | | | | |
| HR (mm) | 17.5 | 17.5 | 17.5 | 17.5 |
| HP (mm) | 35.5 | 35.5 | 35.5 | 35.5 |
| Ho (mm) | — | 26 | 16 | 16 |
| Hi (mm) | — | 21 | 11 | 21 |
| External damage | x | ∘ | x | ∘ |
| resistance | | | | |
| Tire durability | 100 | 90 | 100 | 100 |
| Tire mass | 100 | 110 | 105 | 105 |

The results are as indicated in Table 1. In Comparative Example 2, the damage to the up ply and the down ply could be suppressed. However, the tire durability was degraded, and the tire mass was significantly increased. In Comparative Example 3, an increase in the tire mass and degradation of the tire durability could be suppressed. However, the up ply and the down ply were damaged. Meanwhile, in Example 1, while the increase in the tire mass and the degradation of the tire durability were suppressed, the damage to the up ply and the down ply during the attachment of the tire to the rim and the detachment of the tire from the rim could be suppressed.

What is claimed is:

1. A pneumatic tire comprising:
a pair of bead sections, each of which has a bead core and a bead filler that is disposed on an outer side in a tire radial direction of the bead core;
an up ply having: a main body section that is provided between the pair of bead sections; and wound sections, each of which extends from the main body section, is folded around the bead core from an inner side to an outer side in a tire axial direction, and is wound up to the outer side in the tire radial direction;
a down ply that is provided on a tire outer surface side of the up ply and has portions, each of which overlaps the wound section in the tire axial direction; and
cord reinforcing layers, each of which is provided from the inner side to the outer side in the tire axial direction of the bead core to cover the up ply around the bead core and has reinforcing cords, wherein
a tip of each of the wound sections is located outward in the tire radial direction from a rim flange,
an outer end in the tire axial direction of each of the cord reinforcing layers is located outward in the tire radial direction from a bead upper line and is located inward in the tire radial direction from the rim flange, the bead upper line extending from an outer surface in the tire radial direction of the bead core, and
an inner end in the tire axial direction of each of the cord reinforcing layers is located outward in the tire radial direction from the rim flange.

2. The pneumatic tire according to claim 1, wherein
the reinforcing cords include: plural first reinforcing cords that are arranged in parallel; and plural second reinforcing cords that are arranged in parallel, and
the first reinforcing cords and the second reinforcing cords are arranged to cross each other, so as to define a mesh pattern.

3. The pneumatic tire according to claim 2, wherein
on the outer side in the tire axial direction of each of the bead cores, the cord reinforcing layer is provided between the up ply and the down ply.

4. The pneumatic tire according to claim 2, wherein
each of the first reinforcing cords defines an angle of +35° to +55° with respect to a ply cord provided in the up ply, and
each of the second reinforcing cords defines an angle of −35° to −55° with respect to the ply cord provided in the up ply.

5. The pneumatic tire according to claim 1 further comprising:
a pair of sidewall sections that are provided on the outer sides in the tire radial direction of the pair of bead sections; and
reinforcing rubber layers, each of which is provided on the tire outer surface side of the cord reinforcing layer, wherein
rubber that constitutes the reinforcing rubber layers has a higher modulus in 100% elongation than sidewall rubber provided in the sidewall sections.

6. The pneumatic tire according to claim 5 further comprising:
cushion rubber layers, each of which is provided between the down ply and the reinforcing rubber layer, wherein
rubber that constitutes the cushion rubber layers has a modulus in 100% elongation that is equal to or higher than 85% and is equal to or lower than 90% of that of rubber constituting the bead fillers.

7. The pneumatic tire according to claim 3, wherein
each of the first reinforcing cords defines an angle of +350 to +55° with respect to a ply cord provided in the up ply, and
each of the second reinforcing cords defines an angle of −35° to −55° with respect to the ply cord provided in the up ply.

8. The pneumatic tire according to claim 2 further comprising:
a pair of sidewall sections that are provided on the outer sides in the tire radial direction of the pair of bead sections; and
reinforcing rubber layers, each of which is provided on the tire outer surface side of the cord reinforcing layer, wherein
rubber that constitutes the reinforcing rubber layers has a higher modulus in 100% elongation than sidewall rubber provided in the sidewall sections.

9. The pneumatic tire according to claim 3 further comprising:
a pair of sidewall sections that are provided on the outer side in the tire radial direction of the pair of bead sections; and
reinforcing rubber layers, each of which is provided on the tire outer surface side of the cord reinforcing layer, wherein
rubber that constitutes the reinforcing rubber layers has a higher modulus in 100% elongation than sidewall rubber provided in the sidewall sections.

10. The pneumatic tire according to claim 4 further comprising:
a pair of sidewall sections that are provided on the outer side in the tire radial direction of the pair of bead sections; and
reinforcing rubber layers, each of which is provided on the tire outer surface side of the cord reinforcing layer, wherein
rubber that constitutes the reinforcing rubber layers has a higher modulus in 100% elongation than sidewall rubber provided in the sidewall sections.
